(19) United States
(12) Patent Application Publication
(10) Pub. No.: US 2004/0199366 A1
(43) Pub. Date: Oct. 7, 2004

(54) Mixed signal analog connectivity check system

(76) Inventor: Timothy Holm, Bloomington, MN (US)

Correspondence Address: LSI LOGIC CORPORATION, 1621 BARBER LANE, MS: D-106 LEGAL, MILPITAS, CA, 95035, US

(21) Appl. No.: 10/404,498

(22) Filed: Apr. 1, 2003

(51) Int. Cl. G06G 7/48

(52) U.S. Cl. 703/4

(57) ABSTRACT

A method for verifying connectivity in a mixed signal core environment relies upon comparisons of an input analog value and a derived analog value to determine if the simulation program is operating properly. The method is particularly directed to testing analog cells. The method inputs the analog value into the simulation program only when the analog value changes in value.

### FIELD OF THE INVENTION

The present invention generally relates to the field of testing, and particularly to a mixed signal analog connectivity check system and method.

### BACKGROUND OF THE INVENTION

Analog data in a Verilog model is passed hierarchically into behavioral models from a test bench. Current systems convert the real values passed in the hierarchy into a digital word. The digital word is serially passed into the behavioral model through the actual digital net connection. The model compares the hierarchical expected analog value to the reconverted digital representation and flags an error if a discrepancy is discovered. A disadvantage of current systems is that the test bench and behavioral model are complicated. A further disadvantage is that, when a simulation is run, behavior from the analog stimulus may be obtained even if the actual net is not connected or is connected incorrectly.

Therefore, it would be desirable to provide a method of verifying that an analog signal is truly connected during simulations.

### SUMMARY OF THE INVENTION

Accordingly, the present invention is directed to a method of verifying that an analog signal is truly connected during simulations.

In a first aspect of the present invention, a method and computer readable programmable medium for verifying a connection for an analog signal input into a simulation, comprises the steps of inputting an analog signal into a simulation program; comparing a value of the analog signal with a recently sampled value of the analog signal and, if the value of the analog signal is not the same as the recently sampled value, then performing a simulation using the value of the analog signal.

In a second aspect of the present invention, a computer readable programmable medium is readable by an information handling system whose contents cause the information handling system to execute steps for verifying simulation in a mixed signal environment. A system for verifying a simulation for an analog cell, comprises a test bench and a chip having a mixed signal core, the mixed signal core including an analog cell. The test bench provides an analog signal to the analog cell only when there has been a change in the magnitude of the analog signal.

An advantage of the present invention is that an incorrectly connected or unconnected analog signal input is detectable.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates a flow chart of method steps for an embodiment of the present invention; and

FIG. 2 illustrates a functional diagram of the present invention.

### DETAILED DESCRIPTION OF THE INVENTION

Reference will now be made in detail to the presently preferred embodiments of the invention, examples of which are illustrated in the accompanying drawings.

The analog connectivity check system verifies that the analog nets in a Verilog netlist are connected to the proper pins between the cell boundary and chip boundary without a manual check. This is required since real values are hierarchically driven and monitored at the cell boundary within a test bench. By hierarchically referencing a real analog signal from a test bench the actual net from the cell boundary to the chip boundary is not verified during simulation.

Real values are used within a behavioral model for a mixed signal cell in order to allow a user to provide a voltage or current value for an analog signal instead of a standard logic level. These real values are only available within the cell behavioral model and the test bench. In order to access and stimulate these real values a user must reach down into the behavioral model from within the test bench.

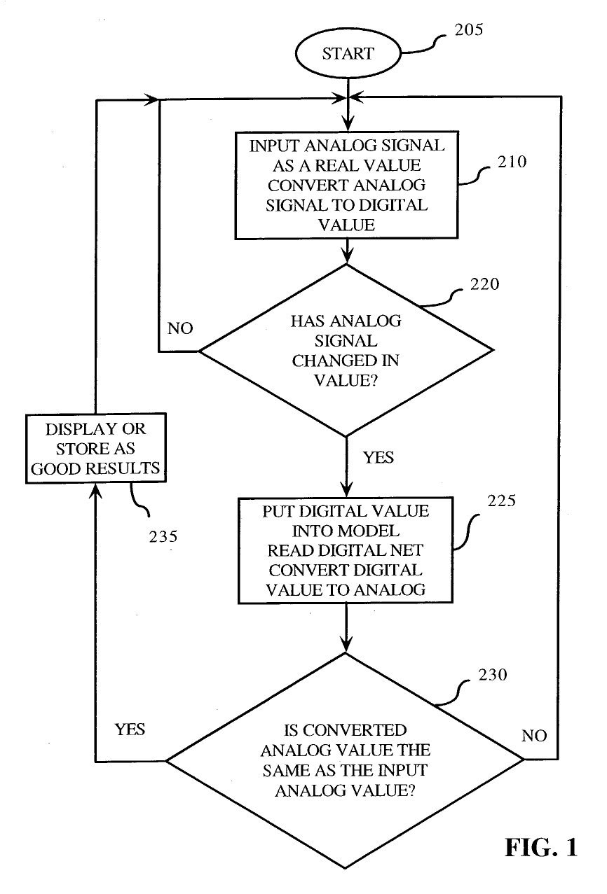

FIG. 1 illustrates an embodiment of a method of the present invention. The method is directed to the simulation of the performance of an analog cell from a test bench. Preferably, the simulation is a verilog simulation; however, other hardware description language (HDL) simulations may be implemented using the method of the present invention. In operation, an analog signal is input as a real value (210). The analog signal may be a sample of a real time or live analog signal that has been digitized, as through analog-to-digital converters, and latched. Alternatively, it may be stored in a digital representation in a memory as a test point. The digital representation could be implemented through a table in the simulation program's software code or be imported through other software programs. A record of previously sampled analog signals is accessed to provide a previously sampled value of the analog signal. Preferably, the accessed sampled value is the last sampled value. This value is compared to the presently sampled value of the analog signal (220). If there has been no change in value, then the program waits for the next sampled value of the analog signal (210). Otherwise, the digitized value of the analog signal is input into the behavioral model of the simulation program (225). The digital value representing the analog value is reconverted to an analog value (225). A comparison is made between the reconverted analog value and the input analog value (230). If the two values are the same (230), a signal may be sent to the user validating the operation of the simulation (235). The validation operation preferably is used to verify that the analog signal is actually provided to the simulation program. This validation could be manifested as a display on a display screen, the lighting of a light emitting diode, an audible alarm, or the like. If the values are different, a signal of a different kind may be transmitted to the user (240). This signal indicating unequal values may be represented on a display or through an indicator light and/or alarm. The history of changes of the value of the analog signal may be used to provide plots of the input and reconverted analog signal values over time. Thresholds may be set to ignore minor changes in magnitude of the analog signal. Cumulative changes in a specific direction (i.e., increasing or decreasing) may be recorded, processed, and displayed. Other variants of processing the signal information may be implemented in the present invention.

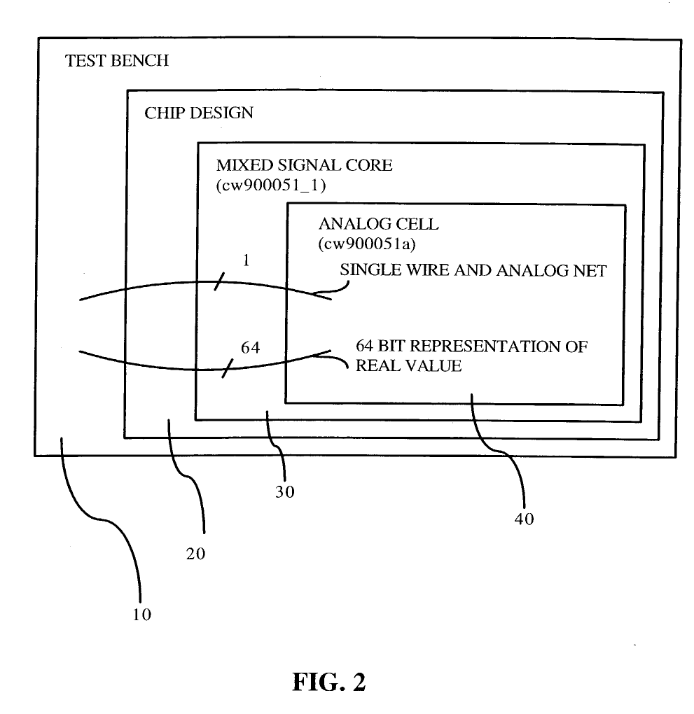

FIG. 2 illustrates a functional diagram of an analog connectivity check system for verifying the operation of an analog cell. The input and output test signal passes from the test bench 10, through the chip 20, to the analog cell 40 of the mixed signal core 30. In one embodiment, a single wire analog net defines the actual pin to pin connection that the analog signal wire is routed between. This signal is visible in each module port list throughout the chip design. In this embodiment, the analog connectivity check system of the present invention monitors a bit pattern on the single channel net that is based on the 64 bit representation of the real value being hierarchically driven in. The 64 bit representation only exists within the test bench and the analog cell behavioral model. Hierarchical referencing is done to make the connection. If the analog connectivity check system detects a bit pattern that does not match the expected bit pattern, an error is output to the STDOUT detailing a connection failure on the net. Various cores 30 may be used. Throughout the application, the cw900051_1 core has been used as illustrative of the cores that may be used in the present invention. The cw900051a cell 40 has been used as an exemplary analog cell. The analog cell cw900051a has an interface wrapper associated with it named cw900051a.v. Within this file half of the analog connectivity check system has been implemented. The other half is implemented in the example test provided with the core tb_cw900051_1.v.

Code for an exemplary implementation of the present invention is provided below. The following code provides an implementation of the tb_cw900051_1.v =l test bench with the actual test vectors removed to help define the connectivity system.

The section above defines the hierarchical path to the cell within the chip design. Changing the path shown to point to the instantiation of the cell usually requires inserting an additional hierarchy similar to as follows:

‘define cw900051_1_PATH <the sve>.<the chip
hierarchy>.cw900051_1inst.cw900051a_1
// Single channel signals for analog inputs. These channels are
fed patterns from
// the connectivity test in the analog interface shell
CW900051a.v to verify analog
// signals are connected correctly.
reg cw900051_1_AVDD_BIT;
reg cw900051_1_AVSS_BIT;
reg cw900051_1_AVSSM_BIT;
reg cw900051_1_AVSSP_BIT;
reg cw900051_1_AVSSR_BIT;
reg cw900051_1_RSET_BIT;
reg cw900051_1_VREF_BIT;
// Single channel signals for analog outputs. These channels are
fed patterns from
// the connectivity test below to verify analog signals are
connected correctly.
wire cw900051_1_OUTM_BIT;
wire cw900051_1_OUTM_0_BIT;
wire cw900051_1_OUTM_1_BIT;
wire cw900051_1_DACOUTM_HZ_BIT;
wire cw900051_1_OUTP_BIT;
wire cw900051_1_OUTP_0_BIT;
wire cw900051_1_OUTP_1_BIT;
wire cw900051_1_DACOUTP_HZ_BIT;

The sectio above defines the registers and wires that are stimulated with special bit patterns in the analog connectivity check system. No modification is required for these definitions. These definitions may be copied to the test bench as is.

cw900051_1 cw900051_1inst (
.outm (cw900051_1_OUTM_BIT),
.outm_0 (cw900051_1_OUTM_0_BIT),
.outm_1 (cw900051_1_OUTM_1_BIT),
.dacoutm_hz (cw900051_1_DACOUTM_HZ_BIT),
.outp (cw900051_1_OUTP_BIT),
.outp_0 (cw900051_1_OUTP_0_BIT),
.outp_1 (cw900051_1_OUTP_1_BIT),
.dacoutp_hz (cw900051_1_DACOUTP_HZ_BIT),
.tap (cw900051_1_TAP),
.avdd (cw900051_1_AVDD_BIT),
.avss (cw900051_1_AVSS_BIT),
.avssm (cw900051_1_AVSSM_BIT),
.avssp (cw900051_1_AVSSP_BIT),
.avssr (cw900051_1_AVSSR_BIT),
.rset (cw900051_1_RSET_BIT),
vref (cw900051_1_VREF_BIT),
clk (cw900051_1_CLK),
din (cw900051_1_DIN),
.dintest (cw900051_1_DINTEST),
.gain (cw900051_1_GAIN),
.gaintest (cw900051_1_GAINTEST),
.in_sel (cw900051_1_IN_SEL),
.ofset (cw900051_1_OFSET),
.ofsetenable (cw900051_1_OFSETENABLE),
.ofsettest (cw900051_1_OFSETTEST),
.outsel (cw900051_1_OUTSEL),
.pdown (cw900051_1_PDOWN)
);

This is the same as the chip instantiation within the test bench. The analog signals are connected to the corresponding signal from the connectivity check system. The names are descriptive. If analog signals are tied together such as AVDD, any corresponding core bit pattern is selected.

/*--------------------------------------------------------------------------------------------*/
// Analog connectivity check system:
// This code represents a connectivity check system that is matched to the
// behavioral model and is imported into the final test bench to automatically
// verify connectivity for analog signals.
// The following assignments are for pattern generation for connectivity checking.
reg [64:1] cw900051_1_AVDD_TRANS;
reg [64:1] cw900051_1_AVSS_TRANS;
reg [64:1] cw900051_1_AVSSM_TRANS;
reg [64:1] cw900051_1_AVSSP_TRANS;
reg [64:1] cw900051_1_AVSSR_TRANS;
reg [64:1] cw900051_1_RSET_TRANS;
reg [64:1] cw900051_1_VREF_TRANS;
reg [64:1] cw900051_1_OUTM_TRANS;
reg [64:1] cw900051_1_OUTM_0_TRANS;
reg [64:1] cw900051_1_OUTM_1_TRANS;
reg [64:1] cw900051_1_DACOUTM_HZ_TRANS;
reg [64:1] cw900051_1_OUTP_TRANS;
reg [64:1] cw900051_1_OUTP_0_TRANS;
reg [64:1] cw900051_1_OUTP_1_TRANS;
reg [64:1] cw900051_1_DACOUTP_HZ_TRANS;
// Analog Input Checks
always @ (‘cw900051_1_PATH.AVDD_REG)
begin
cw900051_1_AVDD_TRANS = ‘cw900051_1_PATH.AVDD_REG;
end
always @ (‘cw900051_1_PATH.AVSS_REG)
begin
cw900051_1_AVSS_TRANS = ‘cw900051_1_PATH.AVSS_REG;
end
always @ (‘cw900051_1_PATH.AVSSM_REG)
begin
cw900051_1_AVSSM_TRANS = ‘cw900051_1_PATH.AVSSM_REG;
end
always @ (‘cw900051_1_PATH.AVSSP_REG)
begin
cw900051_1_AVSSP_TRANS = ‘cw900051_1_PATH.AVSSP_REG;
end
always @ (‘cw900051_1_PATH.AVSSR_REG)
begin
cw900051_1_AVSSR_TRANS = ‘cw900051_1_PATH.AVSSR_REG;
end
always @ (‘cw900051_1_PATH.RSET_REG)
begin
cw900051_1_RSET_TRANS = ‘cw900051_1_PATH.RSET_REG;
end
always @ (‘cw900051_1_PATH.VREF_REG)
begin
cw900051_1_VREF_TRANS = ‘cw900051_1_PATH.VREF_REG;
end
// Analog output checks
always @ (‘cw900051_1_PATH.OUTM_NET)
begin
cw900051_1_OUTM_TRANS = ‘cw900051_1_PATH.OUTM_NET;
end
always @ (‘cw900051_1_PATH.OUTM_0_NET)
begin
cw900051_1_OUTM_0_TRANS = ‘cw900051_1_PATH.OUTM_0_NET;
end
always @ (‘cw900051_1_PATH.OUTM_1_NET)
begin
cw900051_1_OUTM_1_TRANS = ‘cw900051_1_PATH.OUTM_1_NET;
end
always @ (‘cw900051_1_PATH.DACOUTM_HZ_NET)
begin
cw900051_1_DACOUTM_HZ_TRANS
‘cw900051_1_PATH.DACOUTM_HZ_NET;
end
always @ (‘cw900051_1_PATH.OUTP_NET)
begin
cw900051_1_OUTP_TRANS = ‘cw900051_1_PATH.OUTP_NET;
end
always @ (‘cw900051_1_PATH.OUTP_0_NET)
begin
cw900051_1_OUTP_0_TRANS = ‘cw900051_1_PATH.OUTP_0_NET;
end
always @ (‘cw900051_1_PATH.OUTP_1_NET)
begin
cw900051_1_OUTP_1_TRANS = ‘cw900051_1_PATH.OUTP_1_NET;
end
always @ (‘cw900051_1_PATH.DACOUTP_HZ_NET)
begin
cw900051_1_DACOUTP_HZ_TRANS =
‘cw900051_1_PATH.DACOUTP_HZ_NET;
end
// Check for correct pattern on incoming bit streams.
always @ (cw900051_1_OUTM_BIT)
begin
if (cw900051_1_OUTM_TRANS [1] !== cw900051_1_OUTM_BIT)
$display(“Connectivity Error on Analog Pin OUTM”);
end
always @ (cw900051_1_OUTM_0_BIT)
begin
if (cw900051_1_OUTM_0_TRANS [1] !== cw900051_1_OUTM_0_BIT)
$display(“Connectivity Error on Analog Pin OUTM_0”);
end
always @ (cw900051_1_OUTM_1_BIT)
begin
if (cw900051_1_OUTM_1_TRANS [1] !== cw900051_1_OUTM_1_BIT)
$display(“Connectivity Error on Analog Pin OUTM_1”);
end
always @ (cw900051_1_DACOUTM_HZ_BIT)
begin
if (cw900051_1_DACOUTM_HZ_TRANS [1] !==
cw900051_1_DACOUTM_HZ_BIT)
$display(“Connectivity Error on Analog Pin DACOUTM_HZ”);
end
always @ (cw900051_1_OUTP_BIT)
begin
if (cw900051_1_OUTP_TRANS [1] !== cw900051_1_OUTP_BIT)
$display(“Connectivity Error on Analog Pin OUTP”);
end
always @ (cw900051_1_OUTP_0_BIT)
begin
if (cw900051_1_OUTP_0_TRANS [1] !== cw900051_1_OUTP_0_BIT)
$display(“Connectivity Error on Analog Pin OUTP_0”);
end
always @ (cw900051_1_OUTP_1_BIT)
begin
if (cw900051_1_OUTP_1_TRANS [1] !== cw900051_1_OUTP_1_BIT)
$display(“Connectivity Error on Analog Pin OUTP_1”);
end
always @ (cw900051_1_DACOUTP_HZ_BIT)
begin
if (cw900051_1_DACOUTP_HZ_TRANS [1] !==
cw900051_1_DACOUTP_HZ_BIT)
$display(“Connectivity Error on Analog Pin DACOUTP_HZ”);
end
// Check for a change on an analog signal and shift bit patterns
always @ (cw900051_1_AVDD_TRANS or cw900051_1_AVSS_TRANS or
cw900051_1_AVSSM_TRANS or cw900051_1_AVSSP_TRANS or
cw900051_1_AVSSR_TRANS or cw900051_1_VREF_TRANS or
cw900051_1_OUTM_TRANS or cw900051_1_OUTM_0_TRANS or
cw900051_1_OUTM_1_TRANS or cw900051_1_DACOUTM_HZ_TRANS
cw900051_1_OUTP_TRANS or cw900051_1_OUTP_0_TRANS or
cw900051_1_OUTP_1_TRANS or cw900051_1_DACOUTP_HZ_TRANS)
begin
cw900051_1_AVDD_TRANS = cw900051_1_AVDD_TRANS >> 1;
if (cw900051_1_AVDD_TRANS == 0) cw900051_1_AVDD_TRANS =
‘cw900051_1_PATH.AVDD.REG;
cw900051_1_AVDD_BIT = cw900051_1_AVDD_TRANS[1];
cw900051_1_AVSS_TRANS = cw900051_1_AVSS_TRANS >> 1;
if (cw900051_1_AVSS_TRANS == 0) cw900051_1_AVSS_TRANS =
‘cw900051_1_PATH.AVSS.REG;
cw900051_1_AVSS_BIT = cw900051_1_AVSS_TRANS[1];
cw900051_1_AVSSM_TRANS = cw900051_1_AVSSM_TRANS >> 1;
if (cw900051_1_AVSSM_TRANS == 0) cw900051_1_AVSSM_TRANS =
‘cw900051_1_PATH.AVSSM.REG;
cw900051_1_AVSSM_BIT = cw900051_1_AVSSM_TRANS[1];
cw900051_1_AVSSP_TRANS = cw900051_1_AVSSP_TRANS >> 1;
if (cw900051_1_AVSSP_TRANS == 0) cw900051_1_AVSSP_TRANS =
‘cw900051_1_PATH.AVSSP.REG;
cw900051_1_AVSSP_BIT = cw900051_1_AVSSP_TRANS[1];
cw900051_1_AVSSR_TRANS = cw900051_1_AVSSR_TRANS >> 1;
if (cw900051_1_AVSSR_TRANS == 0) cw900051_1_AVSSR_TRANS =
‘cw900051_1_PATH.AVSSR.REG;
cw900051_1_AVSSR_BIT = cw900051_1_AVSSR_TRANS[1];
cw900051_1_RSET_TRANS = cw900051_1_RSET_TRANS >> 1;
if (cw900051_1_RSET_TRANS == 0) cw900051_1_RSET_TRANS =
‘cw900051_1_PATH.RSET.REG;
cw900051_1_RSET_BIT = cw900051_1_RSET_TRANS[1];
cw900051_1_VREF_TRANS = cw900051_1_VREF_TRANS >> 1;
if (cw900051_1_VREF_TRANS == 0) cw900051_1_VREF_TRANS =
‘cw900051_1_PATH.VREF.REG;
cw900051_1_VREF_BIT = cw900051_1_VREF_TRANS[1];
cw900051_1_OUTM_TRANS = cw900051_1_OUTM_TRANS >> 1;
if (cw900051_1_OUTM_TRANS == 0) cw900051_1_OUTM_TRANS =
‘cw900051_1_PATH.OUTM_NET;
cw900051_1_OUTM_0_TRANS = cw900051_1_OUTM_0_TRANS >> 1;
if (cw900051_1_OUTM_0_TRANS == 0) cw900051_1_OUTM_0_TRANS =
‘cw900051_1_PATH.OUTM_0_NET;
cw900051_1_OUTM_1_TRANS = cw900051_1_OUTM_1_TRANS >> 1;
if (cw900051_1_OUTM_1_TRANS == 0) cw900051_1_OUTM_1_TRANS =
‘cw900051_1_PATH.OUTM_1_NET;
cw900051_1_DACOUTM_HZ_TRANS =
cw900051_1_DACOUTM_HZ_TRANS >> 1;
if (cw900051_1_DACOUTM_HZ_TRANS == 0)
cw900051_1_DACOUTM_HZ_TRANS = ‘cw900051_1_PATH.DACOUTM_HZ_NET;
cw900051_1_OUTP_TRANS = cw900051_1_OUTP_TRANS >> 1;
if (cw900051_1_OUTP_TRANS == 0) cw900051_1_OUTP_TRANS =
‘cw900051_1_PATH.OUTP_NET;
cw900051_1_OUTP_0_TRANS = cw900051_1_OUTP_0_TRANS >> 1;
if (cw900051_1_OUTP_0_TRANS == 0) cw900051_1_OUTP_0_TRANS =
‘cw900051_1_PATH.OUTP_0_NET;
cw900051_1_OUTP_1_TRANS = cw900051_1_OUTP_1_TRANS >> 1;
if (cw900051_1_OUTP_1_TRANS == 0) cw900051_1_OUTP_1_TRANS =
‘cw900051_1_PATH.OUTP_1_NET;
cw900051_1_DACOUTP_HZ_TRANS =
cw900051_1_DACOUTP_HZ_TRANS >> 1;
if (cw900051_1_DACOUTP_HZ_TRANS == 0)
cw900051_1_DACOUTP_HZ_TRANS = ‘cw900051_1_PATH.DACOUTP_HZ_NET;
end
/*----------------------------------------------------------------------------------------------*/

This is the connectivity check system code. This code is simply copied to the test bench.

// Signal assignment statements for the various test modes. This is done
to allow
// insertion of the manufacturing test from the test bench without having
to change
// the signal names. In functional mode, this permits the stimulation of
analog
// signals.
always @ (testp)
begin
case (testp)
cw900051_1_FUNC;
begin
assign ‘cw900051_1_PATH.AVDD.REG = $realtobits
(cw900051_1_AVDD);
assign ‘cw900051_1_PATH.AVSS.REG = $realtobits
(cw900051_1_AVSS);
assign ‘cw900051_1_PATH.AVSSM.REG = $realtobits
(cw900051_1_AVSSM);
assign ‘cw900051_1_PATH.AVSSP.REG = $realtobits
(cw900051_1_AVSSP);
assign ‘cw900051_1_PATH.AVSSR.REG = $realtobits
(cw900051_1_AVSSR);
assign ‘cw900051_1_PATH.RSET.REG = $realtobits
(cw900051_1_RSET);
assign ‘cw900051_1_PATH.VREF.REG = $realtobits
(cw900051_1_VREF);
assign cw900051_1_OUTM = $bitstoreal
(‘cw900051_1_OUTM_NET);
assign cw900051_1_OUTM_0 = $bitstoreal
(‘cw900051_1_OUTM_0_NET);
assign cw900051_1_OUTM_1 = $bitstoreal
(‘cw900051_1_OUTM_1_NET);
assign cw900051_1_DACOUTM_HZ = $bitstoreal
(‘cw900051_1_DACOUTM_HZ_NET);
assign cw900051_1_OUTP = $bitstoreal (‘cw900051_1_OUTP_NET);
assign cw900051_1_OUTP_0 = $bitstoreal
(‘cw900051_1_OUTP_0_NET);
assign cw900051_1_OUTP_1 = $bitstoreal
(‘cw900051_1_OUTP_1_NET);
assign cw900051_1_DACOUTP_HZ = $bitstoreal
(‘cw900051_1_DACOUTP_HZ_NET);
end
cw900051_1_T;
begin
assign ‘cw900051_1_PATH.AVDD.REG = $realtobits
(cw900051_1_AVDD);
assign ‘cw900051_1_PATH.AVSS.REG = $realtobits
(cw900051_1_AVSS);
assign ‘cw900051_1_PATH.AVSSM.REG = $realtobits
(cw900051_1_AVSSM);
assign ‘cw900051_1_PATH.AVSSP.REG = $realtobits
(cw900051_1_AVSSP);
assign ‘cw900051_1_PATH.AVSSR.REG = $realtobits
(cw900051_1_AVSSR);
assign ‘cw900051_1_PATH.RSET.REG = $realtobits
(cw900051_1_RSET);
assign ‘cw900051_1_PATH.VREF.REG = $realtobits
(cw900051_1_VREF);
assign cw900051_1_OUTM = $bitstoreal
(‘cw900051_1_OUTM_NET);
assign cw900051_1_OUTM_0 = $bitstoreal
(‘cw900051_1_OUTM_0_NET);
assign cw900051_1_OUTM_1 = $bitstoreal
(‘cw900051_1_OUTM_1_NET);
assign cw900051_1_DACOUTM_HZ = $bitstoreal
(‘cw900051_1_DACOUTM_HZ_NET);
assign cw900051_1_OUTP = $bitstoreal (‘cw900051_1_OUTP_NET);
assign cw900051_1_OUTP_0 = $bitstoreal
(‘cw900051_1_OUTP_0_NET);
assign cw900051_1_OUTP_1 = $bitstoreal
(‘cw900051_1_OUTP_1_NET);
assign cw900051_1_DACOUTP_HZ = $bitstoreal
(‘cw900051_1_DACOUTP_HZ_NET);
end
default:
begin
end
endcase
end

Assign < the type real signal > = $bitstoreal
(‘cw900051_1_PATH.<mixed signal cell 64 bit port name>);

An easy method for implementing this code is to copy the above code to the test bench and then modify the assignments to the real signal names. If the example names have been used and no changes are required. If any analog signals, such as AVDD, have been shared, all associated cores assignment statements may be modified to use the real AVDD signal name. The case statement may be sensitivity to testp where testp refers to the test mode pins of the chip.

During a test bench run, after the analog signals are assigned real values, a message such as *** Automatic Analog Connectivity System Detected for CW900051A and Activated may appear. The appearance of this message and the lack of any connectivity errors during a run indicate that the analog nets are connected correctly.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

What is claimed is:

1. A method for verifying a connection for an analog signal input into a simulation, comprising:
inputting an analog signal into a simulation program;
comparing a value of the analog signal with a recently sampled value of the analog signal; and
if the value of the analog signal is not the same as the recently sampled value, then performing a simulation using the value of the analog signal.

2. The method of claim 1, further comprising digitizing the value of the analog signal.

3. The method of claim 2, wherein the digitized value of the analog signal is used in the simulation.

4. The method of claim 3, wherein the digitized value of the analog signal is used in the comparing step.

5. The method of claim 2, wherein the comparing step compares an analog value of the analog signal.

6. The method of claim 1, further comprising a functional test.

7. The method of claim 1, further comprising a manufacturing test.

8. The method of claim 1, wherein the method verifies if analog nets in a verilog netlist are connected correctly to pins between a cell boundary and a chip boundary.

9. The method of claim 8, wherein the method does not include a manual check.

10. The method of claim 1, wherein the method provides a behavioral model for a mixed signal cell.

11. A computer readable programmable medium readable by an information handling system whose contents cause the information handling system to execute steps for verifying simulation in a mixed signal environment, the steps comprising:
inputting an analog signal into a simulation program;
comparing a value of the analog signal with a recently sampled value of the analog signal; and
if the value of the analog signal is not the same as the recently sampled value, then performing a simulation using the value of the analog signal.

12. The computer readable programmable medium of claim 11, further comprising digitizing the value of the analog signal.

13. The computer readable programmable medium of claim 12, wherein the digitized value of the analog signal is used in the simulation.

14. The computer readable programmable medium of claim 13, wherein the digitized value of the analog signal is used in the comparing step.

15. The computer readable programmable medium of claim 12, wherein the comparing step compares an analog value of the analog signal.

16. The computer readable programmable medium of claim 11, further comprising the steps of analog input checking and analog output checking.

17. The computer readable programmable medium of claim 11, wherein the analog signal is digitized into a digital word.

18. The computer readable programmable medium of claim 17, wherein the digital word is 64 bits long.

19. The computer readable programmable medium of claim 11, further comprising a single wire analog net that defines the actual pin to pin routing connections of the analog signal.

20. A system for verifying a simulation for an analog cell, comprising:
a test bench;
a chip having a mixed signal core, the mixed signal core including an analog cell,
wherein the test bench provides an analog signal to the analog cell only when there has been a change in the magnitude of the analog signal.

21. The system of claim 20, wherein the simulation uses a user time increment and a system time increment.

22. The system of claim 21, wherein a length of the user time increment about one hundred times a length of the system time increment.

23. The system of claim 22, wherein the simulation operates in a manufacturing mode.

24. The system of claim 22, wherein the simulation operates in a functional mode.

25. The system of claim 20, wherein the simulation allows the insertion of a manufacturing test from the test bench without changing signal names.

26. The system of claim 20, wherein the simulation is defined through a hierarchical path.

27. The system of claim 26, wherein the hierarchical path includes a first hierarchical path and a second hierarchical path.

28. The system of claim 27, wherein the first hierarchical path defines a hierarchical path to an analog cell within a chip design and the second hierarchical path defines a hierarchical path for instantiation of the analog cell.

29. The system of claim 20, wherein the simulation provides an indication if no analog signal is present.

30. The system of claim 20, wherein the simulation provides an indication if the analog signal has been incorrectly connected.
